(19) United States
(12) Patent Application Publication
(10) Pub. No.: US 2014/0019282 A1
(43) Pub. Date: Jan. 16, 2014

(54) METHOD AND SYSTEM OF PROVIDING SERVICE USING USER DESCRIPTION, SERVICE DESCRIPTION AND CONTENTS DESCRIPTION

(71) Applicant: Electronics and Telecommunications Research Institute, Daejeon (KR)

(72) Inventors: Sang Hyun JOO, Daejeon (KR); Il Kwon Jeong, Daejeon (KR); Bon Ki Koo, Daejeon (KR); Jin Seok Kim, Seoul (KR); Hyoung Joong Kim, Seoul (KR); Mi Young Lee, Ulsan (KR); Sung Wook Balk, Seoul (KR)

(21) Appl. No.: 13/939,839

(22) Filed: Jul. 11, 2013

(30) Foreign Application Priority Data
Jul. 11, 2012 (KR) 10-2012-0075775
Oct. 15, 2012 (KR) 10-2012-0114091

(51) Int. Cl. G06Q 30/06

(52) U.S. Cl. CPC G06Q 30/0601
USPC 705/26.1

(57) ABSTRACT

A method of providing a service using a user description, a service description, and a contents description may include: receiving first user information from a first user description including first user information; receiving environment information from the contents description including environment information; selecting optimal service information from the service description including service information based on at least one of the first user information and the environment information; and providing a service corresponding to the selected optimal service information to a first user.

### CROSS-REFERENCE TO RELATED APPLICATIONS

This application claims the priority benefit of Korean Patent Application No. 10-2012-0075775, filed on Jul. 11, 2012, and Korean Patent Application No. 10-2012-0114091, filed on Oct. 15, 2012, in the Korean Intellectual Property Office, the disclosures of which are incorporated herein by reference.

### BACKGROUND

1. Field of the Invention

The present invention relates to a system and method for providing a service using a user description (UD), a service description (SD), and a contents description (CD), and more particularly, to a technology of providing, to a user, an assembled user description (AUD) that includes optimal service information.

2. Description of the Related Art

Technology of providing a service to a user may provide a service using only a portion of personal information of a user required in a predetermined service field. Personal information of the user required in each service field may differ and thus, personal information of the user may not be commonly used in each service field. Further, environment information is not considered and thus, an optimal service may not be provided.

### SUMMARY

An aspect of the present invention provides a method, apparatus, and system for providing an optimal service to a first user using a first user description including first user information, a contents description including environment information, and a service description including service information.

Another aspect of the present invention also provides a method, apparatus, and system for providing an assembled user description including service information provided to a first user while providing an optimal service to the first user.

Another aspect of the present invention also provides a method, apparatus, and system for setting a first user description, a contents description, and a service description based on a change in a service provided to a user.

Another aspect of the present invention also provides a method, apparatus, and system for providing an optimal service to a second user using a first description, a contents description, and a service description by providing an assembled user description to the second user.

According to an aspect of the present invention, there is provided a method of providing a service using a user description, a service description, and a contents description, the method including: receiving first user information from a first user description including first user information; receiving environment information from the contents description including environment information; selecting optimal service information from the service description including service information based on at least one of the first user information and the environment information; and providing a service corresponding to the selected optimal service information to a first user.

The providing may include providing, to the first user, an assembled user description including the selected optimal service information.

The service providing method may further include updating the first user description of the first user based on the assembled user description.

The assembled user description may include the selected optimal service information, the first user information, and the environment information.

The first user description, the contents description, and the service description may include information that is set using a predetermined scheme.

The receiving of the first user information may include extracting a first identifier corresponding to the first user information from the first user description.

The receiving of the environment information may include extracting a second identifier corresponding to the environment information from the contents description.

The selecting may include: mapping at least one of a first identifier and a second identifier with an identification table including the service information that is included in the service description; and selecting the service information based on the identification table.

The mapping may include matching at least one of the first identifier and the second identifier with at least one of a plurality of items of service information included in the identification table.

The identification table may include a plurality of identifiers corresponding to a plurality of items of user information, respectively, a plurality of identifiers corresponding to a plurality of items of environment information, respectively, and a plurality of items of service information.

The receiving of the first user information may include receiving a service request from the first user.

The service providing method may further include providing a service corresponding to the selected optimal service information to a second user.

In the case of providing the service to the second user, the service providing method may further include: receiving second user information of the second user from a second user description including second user information, and selecting the optimal service information from the service description including the service information, based on the second user information.

The providing of the service to the second user may include providing, to the second user, an assembled user description including the selected optimal service information.

The assembled user description may include the selected optimal service information, the first user information, the second user information, and the user description including the environment information.

According to another aspect of the present invention, there is provided a system for providing a service using a user description, a service description, and a contents description, the system including: a first user description; the service description; the contents description; and an assembled user description engine. The first user description may include first user information of a first user, the service description may include service information, and the contents description may include environment information.

The assembled user description engine may receive the first user information from the first user description, may receive the environment information from the contents description, may select optimal service information from the service description including the service information based on at least one of the first user information and the environment information, and may provide a service corresponding to the selected optimal service information to the first user.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system for providing a service using a user description, a service description, and a contents description according to an embodiment of the present invention;

FIG. 2 is a diagram illustrating a method of providing a service using a user description, a service description, and a contents description according to an embodiment of the present invention;

FIG. 3 is a diagram illustrating a method of providing a service using a user description and a service description according to an embodiment of the present invention;

FIG. 4 is a diagram illustrating a method of providing a service to a second user using a user description, a service description, and a contents description according to an embodiment of the present invention; and

FIG. 5 is a flowchart illustrating a method of providing a service using a user description, a service description, and a contents description according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

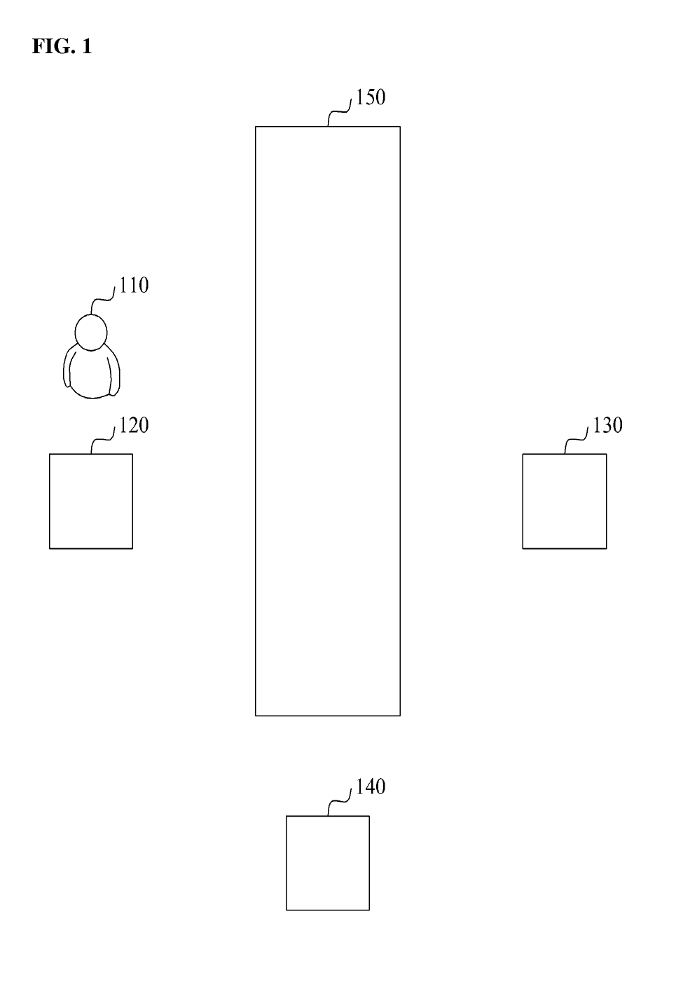

FIG. 1 is a diagram illustrating a system for providing a service using a user description, a service description, and a contents description according to an embodiment of the present invention.

Referring to FIG. 1, the service providing system may include a first user 110, a first user description 120 including first user information of the first user 110, a service description 130 including a plurality of items of service information capable of being supported to the first user 110, a contents description 140 including environment information, and an assembled user description engine 150.

Here, the assembled user description engine 150 may provide an optimal service to the first user 110 by receiving a service request of the first user 110, the first user information, and the environment information, by selecting optimal service information based on the first user information and the environment information in response to the service request of the first user 110, and by providing an assembled user description including a service corresponding to service information.

A process of receiving the first user information from the first user description 120 may correspond to a process of extracting a first identifier corresponding to the first user information. A process of receiving the environment information from the contents description 140 may correspond to a process of extracting a second identifier corresponding to the environment information. Also, a process of selecting service information may correspond to a process of mapping at least one of the first identifier and the second identifier with an identification table including the service information that is included in the service description 130, that is, a process of matching at least one of the first identifier and the second identifier with at least one of a plurality of items of service information included in the identification table.

Also, the first user description 120, the contents description 140, and the service description 130 may be set based on a change in a service provided to the first user 110. That is, the first user description 120, the contents description 140, and the service description 130 may be set by employing a standard including information that is commonly required to provide a service, in order to make it possible to be available over various types of service fields. For example, in the first user description 120, items such as a name, an age, a sex, a home address, a contact number, and position information of the first user 110 may be set based on the standard.

The first user description 120 may be stored in at least one of a portable device, a cloud environment, and a server. For example, the first user description 120 may be stored in a universal subscriber identity module (USIM) mounted to a smart device, and thereby be used.

The service description 130 may also store service information supportable to the first user 110 in at least one of a portable device, a cloud environment, and a server. Service information supportable to the first user 110 may be diversified over various fields. For example, services included in the service description 130 may include services in various fields such as a service for repairing a mobile phone of a user, a navigation service for driving a vehicle, a news providing service, and the like. Further, a service capable of being provided to the first user 110 may include all of the services applicable by those skilled in the art.

The contents description 140 may include environment information associated with the first user 110. For example, the contents description 140 may include weather information and traffic information associated with a region in which the first user 110 is positioned.

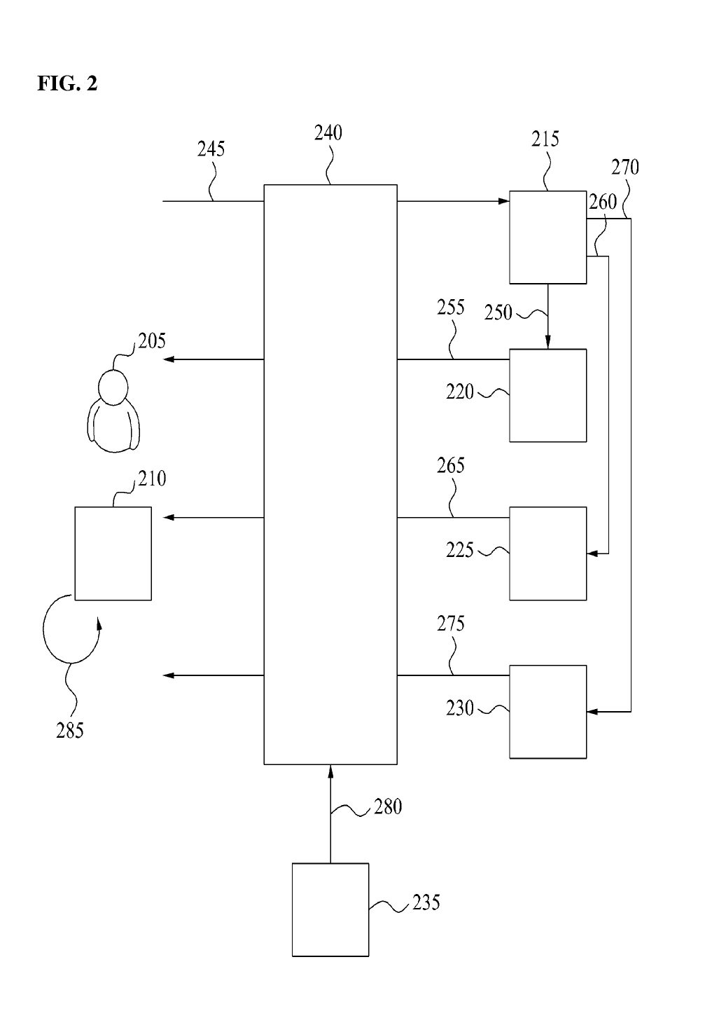

FIG. 2 is a diagram illustrating a method of providing a service using a user description, a service description, and a contents description according to an embodiment of the present invention.

FIG. 2 illustrates a first user 205, a first user description 210 including first user information of the first user 205, a first service description 215, a second service description 220, a third service description 225, and a fourth service description 230, each including service information supportable to the first user 205, a contents description 235 including environment information, and an assembled user description engine 240.

The first user description 210 including the first user information, the first service description 215, the second service description 220, the third service description 225, and the fourth service description 230, and the contents description 235 may include information set using a predetermined scheme in accordance with a standard.

The service providing method of FIG. 2 will be described based on an example in which the first user 205 meets with a vehicle accident.

In operation 245, the first user 205 may request an insurance company including the first service description 215 about an insurance service for a service. Here, the assembled user description engine 240 may extract position information of the first user 205 from the first user description 210, and may transmit the extracted position information to the insurance company.

In operation 250, the insurance company may request a towing service company including the second service description 220 about a towing service for dispatching a towing vehicle. In operation 255, the towing service company may provide the towing service to the first user 205 based on position information of the first user 205 and environment information received from the contents description 235 in operation 280, through the assembled user description engine 240.

In operation 260, the insurance company may request a vehicle repair shop including the third service description 225 about a vehicle repair service for repairing a vehicle of the first user 205. In operation 265, the vehicle repair shop may repair the vehicle of the first user 205 included in the first user description 210, through the assembled user description engine 240.

In operation 270, a rental car company may receive a rental request of the first user 205. In response to the request, the rental car company may provide a rental service included in the fourth service description 230 to the first user 205 based on personal preference information of the first user 205 included in the first user description 210, through the assembled user description engine 240 in operation 275. Here, the first user 205 may drive a rental car based on the first user information of the first user description 210 and traffic information of the contents description 235.

In operation 285, the first user description 210 may update changes in the first user information, based on provided service information. For example, vehicle information of the first user 205 included in the first user description 210 may be changed with renting a vehicle, and accident history information may be changed with information indicating the presence of an accident.

As described above, the assembled user description including the towing service, the vehicle repairing service, and the rental car service, which are provided to the first user 205 in operations 255, 265, and 275, may be collectively provided based on the first user information and the environment information. The environment information may include traffic information and weather information, and the environment information may be set in the contents description 235.

Also, the assembled user description may select optimal service information from among service descriptions based on at least one of the first user description 210 and the contents description 235, and may provide the selected optimal service information. Hereinafter, an embodiment in which optimal service information is provided among service descriptions based on the first user description 210 alone without considering the contents description 235 will be described.

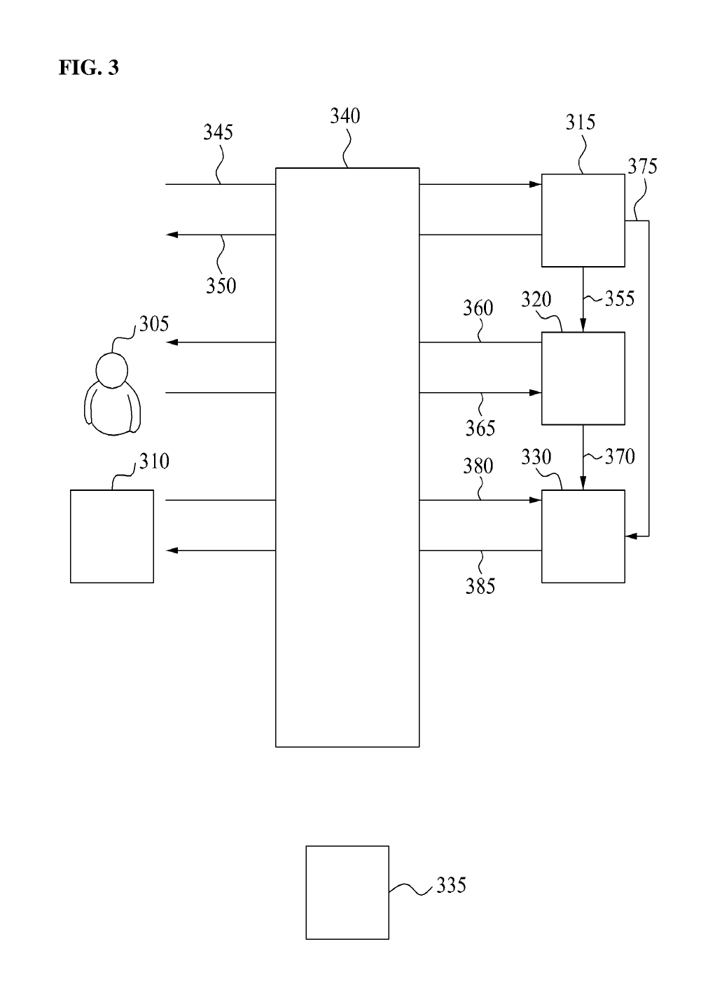

FIG. 3 is a diagram illustrating a method of providing a service using a user description and a service description according to an embodiment of the present invention.

Referring to FIG. 3, a first user 305, a first user description 310 including first user information of the first user 305, a first service description 315, a second service description 320, and a third service description 325, each including service information supportable to the first user 305, a contents description 330 including environment information, and an assembled user description engine 335.

The service providing method of FIG. 3 will be described based on an example in which the first user 305 purchases clothes using a home shopping service.

In operation 340, the first user 305 may request a home shopping company including the first service description 315 about clothes information for a display service. Here, the assembled user description engine 335 may extract body size information of the first user 305 from the first user description 310, and may transmit the extracted body size information to the home shopping company. In operation 345, the home shopping company may display suitable clothes for the first user 345 based on body size information of the first user 305.

When the first user 305 selects desired clothes, the home shopping company may transmit an identifier (ID) of the first user 305 and an amount of the selected clothes to a bank including the second service description 320 about payment information, in operation 350. In operation 355, the bank may request the first user 305 for paying the corresponding amount. In operation 360, the assembled user description engine 335 may make a payment based on account information of the first user 305 included in the first user information and a request of the first user 305.

In operation 365, the bank may transmit payment information of the first user 305 to a delivery company including the third service description 365 about a delivery service. In operation 370, the home shopping company may request the delivery company to deliver the selected clothes to the first user 305. The delivery company may receive address information of the first user 305 from the first user description 310 in operation 375, and may deliver the selected clothes to the first user 305 based on the received address information in operation 380.

Here, an assembled user description provided to the first user 305 may select an optimal service from service descriptions, for example, the first service description 315, the second service description 320, and the third service description 325, based on the first user description 310 alone, and may provide the selected optimal service. For example, the contents description 330 including environment information may not be used for a predetermined process of selecting the optimal service provided to the first user 305.

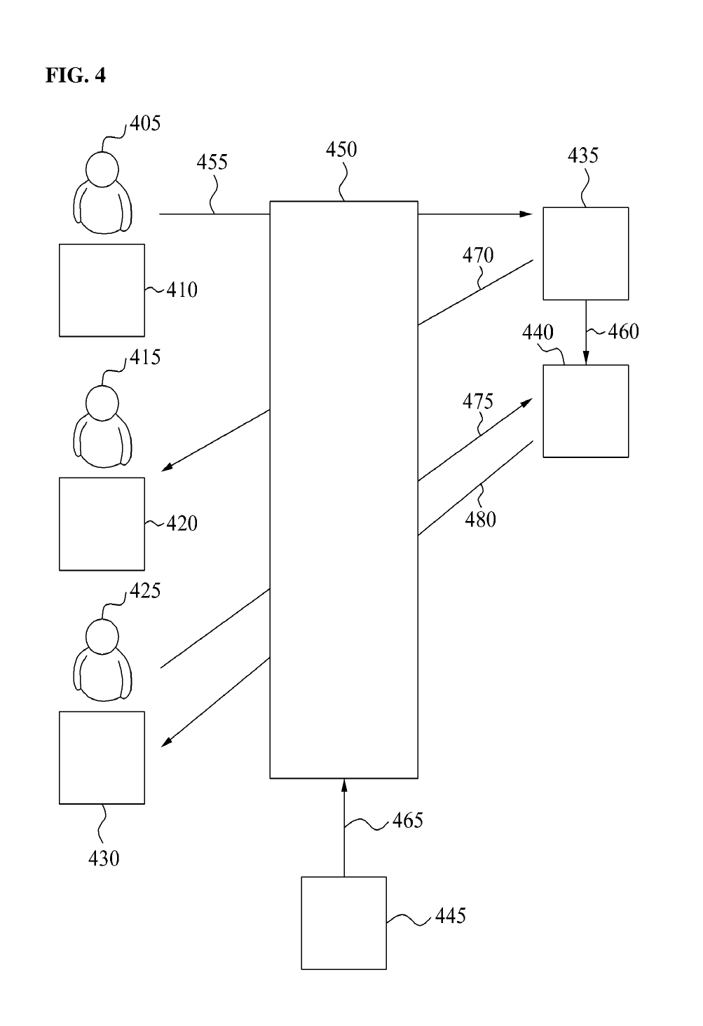

FIG. 4 is a diagram illustrating a method of providing a service to a second user using a user description, a service description, and a contents description according to an embodiment of the present invention.

FIG. 4 illustrates a first user 405, a first user description 410 including first user information of the first user 405, a second user 415, a second user description 420 including second user description of the second user 415, a third user 425, a third user description 430 including third user description of the third user 425, a first service description 435 and a second service description 440, each including service information supportable to each of the first user 405, the second user 415, and the third user 425, a contents description 445 including environment information, and an assembled user description engine 450.

The service providing method of FIG. 4 will be described based on an example in which the first user 405 witnesses a crime scene in which the second user 415 is committing a crime targeted at the third user 425.

In operation 455, the first user 405 may report a crime to the police station including the first service description 435 about a police service. Here, in operation 455, the assembled user description engine 450 may extract position information of the first user 405 from the first user description 410, and may transmit the extracted position information to the police station.

In operation 465, the police station may receive position information of the first user 405 and traffic information included in the contents description 445. In operation 470, the police station may dispatch the police to arrest the second user 415 based on the received position information and traffic information.

In operation 460, the police station may request a hospital including the second service description 440 about a medical service to dispatch an ambulance.

In operation 480, the hospital may make a dispatch in order to provide a medical service to the third user 425 based on position information of the first user 405 and traffic information. After arriving at the crime scene, medical record information of the third user 425 may be received in operation 475. Based thereon, an optimal medical service may be provided to the third user 425.

As described above, the assembled user description engine 450 may make it possible to quickly arrest the second user 415 and to further quickly provide the medical service to the third user 425 by receiving traffic information and weather information from the contents description 445 and by transmitting the received traffic information and weather information to the police station and the hospital.

Also, it is possible to provide a service to the second user 415 and the third user 425 using the first user description 410 that includes first user information. For example, it is possible to provide a service to the second user 415 using the first user description 410 of the first user 405, instead of using the second user description 420.

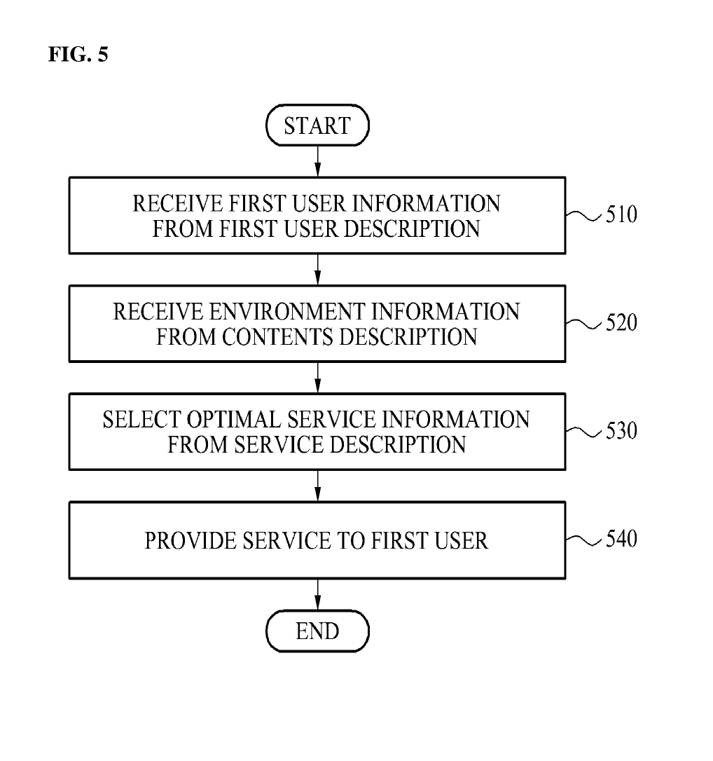

FIG. 5 is a flowchart illustrating a method of providing a service using a user description, a service description, and a contents description according to an embodiment of the present invention.

Referring to FIG. 5, in operation 510, first user information may be received from a first user description.

In operation 520, environment information may be received from a contents description.

Here, operation 510 may be an operation of extracting a first identifier corresponding to the first user information. Operation 520 may be an operation of extracting a second identifier corresponding to the environment information.

In operation 530, optimal service information may be selected from among service descriptions including service information based on at least one of the first user information and the environment information.

Here, operation 530 may be an operation of mapping at least one of the first identifier and the second identifier with an identification table including the service information that is included in the service description, for example, an operation of matching at least one of the first identifier and the second identifier with at least one of a plurality of items of service information included in the identification table.

In operation 540, an optimal service corresponding to the selected service information may be provided to the first user. Operation 540 may be an operation of providing the first user with an assembled user description including the selected service information.

Also, the first user description of the first user may be additionally updated based on the assembled user description.

According to embodiments of the present invention, there may be provided a method, apparatus, and system for providing an optimal service to a first user using a first user description including first user information, a contents description including environment information, and a service description including service information.

Also, according to embodiments of the present invention, there may be provided a method, apparatus, and system for providing an assembled user description including service information provided to a first user while providing an optimal service to the first user.

Also, according to embodiments of the present invention, there may be provided a method, apparatus, and system for setting a first user description, a contents description, and a service description based on a change in a service provided to a user.

Also, according to embodiments of the present invention, there may be provided a method, apparatus, and system for providing an optimal service to a second user using a first description, a contents description, and a service description by providing an assembled user description to the second user.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of providing a service using a user description, a service description, and a contents description, the method comprising:
receiving first user information from a first user description including first user information;
receiving environment information from the contents description including environment information;
selecting optimal service information from the service description including service information based on at least one of the first user information and the environment information; and
providing a service corresponding to the selected optimal service information to a first user.

2. The method of claim 1, wherein the providing comprises providing, to the first user, an assembled user description including the selected optimal service information.

3. The method of claim 2, further comprising:
updating the first user description of the first user based on the assembled user description.

4. The method of claim 2, wherein the assembled user description includes the selected optimal service information, the first user information, and the environment information.

5. The method of claim 1, wherein the first user description, the contents description, and the service description include information that is set using a predetermined scheme.

6. The method of claim 1, wherein the receiving of the first user information comprises extracting a first identifier corresponding to the first user information from the first user description.

7. The method of claim 1, wherein the receiving of the environment information comprises extracting a second identifier corresponding to the environment information from the contents description.

8. The method of claim 1, wherein the selecting comprises:
mapping at least one of a first identifier and a second identifier with an identification table including the service information that is included in the service description; and
selecting the service information based on the identification table.

9. The method of claim 8, wherein the mapping comprises matching at least one of the first identifier and the second identifier with at least one of a plurality of items of service information included in the identification table.

10. The method of claim 8, wherein the identification table includes a plurality of identifiers corresponding to a plurality of items of user information, respectively, a plurality of identifiers corresponding to a plurality of items of environment information, respectively, and a plurality of items of service information.

11. The method of claim 1, wherein the receiving of the first user information comprises receiving a service request from the first user.

12. The method of claim 1, further comprising:
providing a service corresponding to the selected optimal service information to a second user.

13. The method of claim 12, further comprising:
in the case of providing the service to the second user,
receiving second user information of the second user from a second user description including second user information; and
selecting the optimal service information from the service description including the service information, based on the second user information.

14. The method of claim 12, wherein the providing of the service to the second user comprises providing, to the second user, an assembled user description including the selected optimal service information.

15. The method of claim 14, wherein the assembled user description includes the selected optimal service information, the first user information, the second user information, and the user description including the environment information.

16. A system for providing a service using a user description, a service description, and a contents description, the system comprising:
a first user description;
the service description;
the contents description; and
an assembled user description engine,
wherein the first user description includes first user information of a first user, the service description includes service information, and the contents description includes environment information.

17. The system of claim 16, wherein the assembled user description engine receives the first user information from the first user description, receives the environment information from the contents description, selects optimal service information from the service description including the service information based on at least one of the first user information and the environment information, and provides a service corresponding to the selected optimal service information to the first user.
